(19) United States
(12) Patent Application Publication
(10) Pub. No.: US 2004/0064500 A1
(43) Pub. Date: Apr. 1, 2004

(54) System and method for unified extraction of media objects

(76) Inventors: Jennifer Lynn Kolar, Seattle, WA (US); Brad Steven Miller, Mercer Island, WA (US); Scott Chao-Chueh Lee, Belevue, WA (US)

Correspondence Address: Joseph S Tripoli, Thomson Multimedia Licensing Inc, P O Box 5312, Princeton, NJ, 08543-5312, US

(21) Appl. No.: 10/432,316

(22) PCT Filed: Nov. 20, 2001
(86) PCT No.: PCT/US01/43305

(51) Int. Cl. G06F 15/16

(52) U.S. Cl. 709/202; 709/246

(57) ABSTRACT

A system and method for extracting information, such as metadata, from a media object, such as a multimedia object or a streaming media object, utilizes a single device (44) to extract the information from a plurality of media objects having different formats. The media object is examined to determine its format (40). The media object is then provided to a multi-format extractor (44), wherein information is extracted from the media object in accordance with the appropriate format. The extracted information is compiled (46) into a singular data structure, such that the format of the universal data structure is compatible with a plurality of media object formats (30).

The field of this invention relates generally to computer related information search and retrieval, and more specifically to extraction of metadata from media objects.

As background to understanding the invention, an aspect of the Internet (also referred to as the World Wide Web, or Web) contributing to its popularity is the plethora of multimedia and streaming media files available to users. However, finding a specific multimedia or streaming media file buried among the millions of files on the Web is often an extremely difficult task. The volume and variety of informational content available on the web is likely to continue to increase at a rather substantial pace. This growth, combined with the highly decentralized nature of the web, creates substantial difficulty in locating particular informational content.

Streaming media refers to audio, video, multimedia, textual, and interactive data files that are delivered to a user's computer via the Internet or other network environment and begin to play on the user's computer before delivery of the entire file is completed. One advantage of streaming media is that streaming media files begin to play before the entire file is downloaded, saving users the long wait typically associated with downloading the entire file. Digitally recorded music, movies, trailers, news reports, radio broadcasts and live events have all contributed to an increase in streaming content on the Web. In addition, less expensive high-bandwidth connections such as cable, DSL and T1 are providing Internet users with speedier, more reliable access to streaming media content from news organizations, Hollywood studios, independent producers, record labels and even home users.

A user typically searches for specific information on the Internet via a search engine. A search engine comprises a set of programs accessible at a network site within a network, for example a local area network (LAN), the Internet, and World Wide Web. Programs called “robots” or “spiders”, pre-traverse a network in search of documents (e.g., web pages) and other programs, and build large index files of keywords found in the documents. Typically, a user formulates a query comprising one or more search terms and submits the query to another program of the search engine. In response, the search engine inspects its own index files and displays a list of documents that match the search query, typically as hyperlinks. The user may then activate one of the hyperlinks to see the information contained in the document.

When searching for media files, such as multimedia and streaming media, extractors are utilized to extract information pertaining to the media file. Media files, also referred to as media objects, exist in various formats, such as WINDOW MEDIA PLAYER® and REAL AUDIO®. Typically, a unique extractor, compatible with only the specific media format is utilized. For example, an extractor compatible with the WINDOW MEDIA PLAYER® format is not compatible with a media object formatted in the REAL AUDIO® format. Also, the structure of metadata contained in the various media objects differs from format to format. In conventional search systems, each media format requires a different extractor to extract relevant information from the media object. The extracted outputs are then processed separately in order to form a search index. The separate processing of each extracted output requires significant system resources. Thus, there is a need for a search system that is not limited by the previously described drawbacks and disadvantages.

The invention is a system for extracting information from media objects including: a media object classifier, an extractor assignment agent, a multi-format extractor, and a compiler. The media object classifier determines the format of a media object. The extractor assignment agent selects a format compliant extractor compatible with the determined format. The multi-format extractor contains a plurality of extractors, one of which is the format compliant extractor. The format compliant extractor extracts the information from the media object. The compiler compiles the extracted information in accordance with a universal data structure, wherein the format of the universal data structure is compatible with a plurality of media object formats.

### BRIEF DESCRIPTION OF THE DRAWINGS

The invention is best understood from the following detailed description when read in connection with the accompanying drawings. The various features of the drawings may not be to scale. Included in the drawing are the following figures:

FIG. 1 is a stylized overview illustration of a system of interconnected computer system networks;

FIG. 2 is a flow diagram of a process for performing unified extraction in accordance with the present invention; and

FIG. 3 is a functional block diagram of a unified extractor in accordance with the present invention.

The Internet is a worldwide system of computer networks that is a network of networks in which users at one computer can obtain information from any other computer and communicate with users of other computers. The most widely used part of the Internet is the World Wide Web (often-abbreviated “WWW” or called “the Web”). An outstanding feature of the Web is its use of hypertext, which is a method of cross-referencing. In most Web sites, certain words or phrases appear in text of a different color than the surrounding text. This text is often also underlined. Sometimes, there are buttons, images or portions of images that are “clickable.” Using the Web provides access to millions of pages of information. Web “surfing” is done with a Web browser; such as NETSCAPE NAVIGATOR® and MICROSOFT INTERNET EXPLORER®. The appearance of a particular website may vary slightly depending on the particular browser used. Recent versions of browsers have “plug-ins,” which provide animation, virtual reality, sound and music.

As used herein, the terms “media file” and “media object” include audio, video, textual, multimedia data files, and streaming media files. Multimedia files comprise any combination of text, image, video, and audio data. Streaming media comprises audio, video, multimedia, textual, and interactive data files that are delivered to a user's computer via the Internet or other communications network environment and begin to play on the user's computer/device before delivery of the entire file is completed. One advantage of streaming media is that streaming media files begin to play before the entire file is downloaded, saving users the long wait typically associated with downloading the entire file. Digitally recorded music, movies, trailers, news reports, radio broadcasts and live events have all contributed to an increase in streaming content on the Web. In addition, the reduction in cost of communications networks through the use of high-bandwidth connections such as cable, DSL, T1 lines and wireless networks (e.g., 2.5G or 3G based cellular networks) are providing Internet users with speedier, more reliable access to streaming media content from news organizations, Hollywood studios, independent producers, record labels and even home users themselves.

Examples of streaming media include songs, political speeches, news broadcasts, movie trailers, live broadcasts, radio broadcasts, financial conference calls, live concerts, web-cam footage, and other special events. Streaming media is encoded in various formats including REALAUDIO®, REALVIDEO®, REALMEDIA®, APPLE QUICKTIME®, MICROSOFT WINDOWS® MEDIA FORMAT, QUICKTIME®, MPEG-2 LAYER III AUDIO, and MP3®. Typically, media files are designated with extensions (suffixes) indicating compatibility with specific formats. For example, media files (e.g., audio and video files) ending in one of the extensions, ram, .rm, .rpm, are compatible with the REALMEDIA® format. Some examples of file extensions and their compatible formats are listed in the following table. A more exhaustive list of media types, extensions and compatible formats may be found at http://www.bowers.cc/extensions2.htm.

TABLE 1

| Format | Extension |
|---|---|
| REALMEDIA ® | .ram, .rm, .rpm |
| APPLE QUICKTIME ® | .mov, .qif |
| MICROSOFT | .wma, .cmr, .avi |
| WINDOWS ® MEDIA | |
| PLAYER | |
| MACROMEDIA FLASH | .swt, .swl |
| MPEG | .mpg, .mpa, .mp1, |
| | .mp2 |
| MPEG-2 LAYER III | .mp3, .m3a, .m3u |
| Audio | |

Metadata as descriptive data literally means “data about data.” Metadata is data that comprises information that describes the contents or attributes of other data (e.g., media file). For example, a document entitled, “Dublin Core Metadata for Resource Discovery,” (http://www.ietf.org/rfc/rfc2413.txt) separates metadata into three groups, which roughly indicate the class or scope of information contained therein. These three groups are: (1) elements related primarily to the content of the resource, (2) elements related primarily to the resource when viewed as intellectual property, and (3) elements related primarily to the instantiation of the resource. Examples of metadata falling into these groups are shown in the following table.

TABLE 2

| | Intellectual | |
|---|---|---|
| Content | Property | Instantiation |
| Title | Creator | Date |
| Subject | Publisher | Format |
| Description | Contributor | Identifier |
| Type | Rights | Language |
| Source | | |
| Relation | | |
| Coverage | | |

Sources of metadata include web page content, uniform resource indicators (URIs), media files, and transport streams used to transmit media files. Web page content includes HTML, XML, metatags, and any other text on the web page. As explained in more detail, herein, metadata may also be obtained from the URIs of webpages, media files, and other metadata. Metadata within the media file may include information contained in the media file, such as in a header or trailer, of a multimedia or streaming file, for example. Metadata may also be obtained from the media/metadata transport stream, such as TCP/IP (e.g., packets), ATM, frame relay, cellular based transport schemes (e.g., cellular based telephone schemes), MPEG transport, HDTV broadcast, and wireless based transport, for example. Metadata may also be transmitted in a stream in parallel or as part of the stream used to transmit a media file (a High Definition television broadcast is transmitted on one stream and metadata, in the form of an electronic programming guide, is transmitted on a second stream).

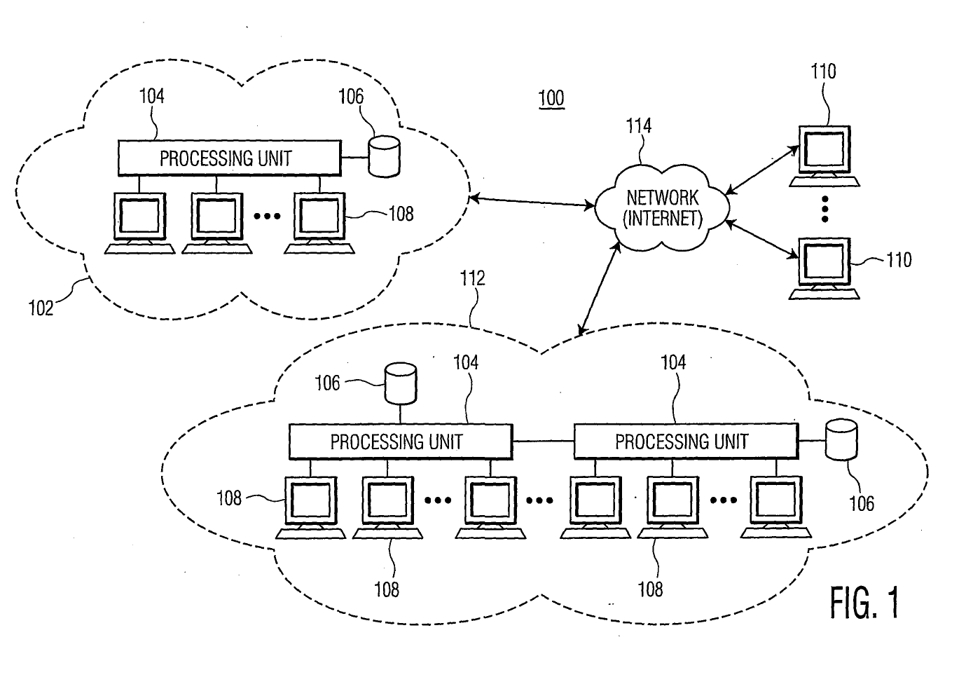

Referring to FIG. 1 there is shown a stylized overview of a system 100 of interconnected computer system networks 102 and 112. Each computer system network 102 and 112 contains at least one corresponding local computer processor unit 104 (e.g., server), which is coupled to at least one corresponding local data storage unit 106 (e.g., database), and local network users 108. A computer system network may be a local area network (LAN) 102 or a wide area network (WAN) 112, for example. The local computer processor units 104 are selectively coupled to a plurality of media devices 110 through the network (e.g., Internet) 114. Each of the plurality of local computer processors 104, the network user processors 108, and/or the media devices 110 may have various devices connected to its local computer systems, such as scanners, bar code readers, printers, and other interface devices. A local computer processor 104, network user processor 108, and/or media device 110, programmed with a Web browser, locates and selects (e.g., by clicking with a mouse) a particular Web page, the content of which is located on the local data storage unit 106 of a computer system network 102, 112, in order to access the content of the Web page. The Web page may contain links to other computer systems and other Web pages.

The local computer processor 104, the network user processor 108, and/or the media device 110 may be a computer terminal, a pager which can communicate through the Internet using the Internet Protocol (IP), a Kiosk with Internet access, a connected electronic planner (e.g., a PALM device manufactured by Palm, Inc.) or other device capable of interactive communication through a network, such as an electronic personal planner. The local computer processor 104, the network user processor 108, and/or the media device 110 may also be a wireless device, such as a hand held unit (e.g., cellular telephone) that connects to and communicates through the Internet using the wireless access protocol (WAP). Networks 102 and 112 may be connected to the network 114 by a modem connection, a Local Area Network (LAN), cable modem, digital subscriber line (DSL), twisted pair, wireless based interface (cellular, infrared, radio waves), or equivalent connection utilizing data signals. Databases 106 may be connected to the local computer processor units 104 by any means known in the art. Databases 106 may take the form of any appropriate type of memory (e.g., magnetic, optical, etc.). Databases 106 may be external memory or located within the local computer processor 104, the network user processor 108, and/or the media device 110.

Computers may also encompass computers embedded within consumer products and other computers. For example, an embodiment of the present invention may comprise computers (as a processor) embedded within a television, a set top box, an audio/video receiver, a CD player, a VCR, a DVD player, a multimedia enable device (e.g., telephone), and an Internet enabled device.

In an exemplary embodiment of the invention, the network user processors 108 and/or media devices 110 include one or more program modules and one or more databases that allow the user processors 108 and/or media devices 110 to communicate with the local processor 104, and each other, over the network 114. The program module(s) include program code, written in PERL, Extensible Markup Language (XML), Java, Hypertext Mark-up Language (HTML), or any other equivalent language which allows the network user processors 108 to access the program module(s) of the local processors 104 through the browser programs stored on the network user processors 108.

Web sites and web pages are locations on a network, such as the Internet, where information (content) resides. A web site may comprise a single or several web pages. A web page is identified by a Uniform Resource Indicator (URI) comprising the location (address) of the web page on the network. Web sites, and web pages, may be located on local area network 102, wide area network 112, network 114, processing units (e.g., servers) 104, user processors 108, and/or media devices 110. Information, or content, may be stored in any storage device, such as a hard drive, compact disc, and mainframe device, for example. Content may be stored in various formats, which may differ, from web site to web site, and even from web page to web page.

In accordance with the present invention, media objects, such as multimedia and streaming media objects, are searched for utilizing metadata related to the media objects. To accomplish this, extractors, also referred to as extraction agents, are utilized to extract metadata from the media objects. An extractor comprises a processor and/or software capable of extracting specific information from a media object. For example, an extractor can be a web crawler that extracts metadata from an ID3 tag associated with an MP3 based music file. In one embodiment of the invention, a unified extractor is utilized; wherein the unified extractor comprises the capability to extract information from a plurality of media formats and provides this information in a single common output representation.

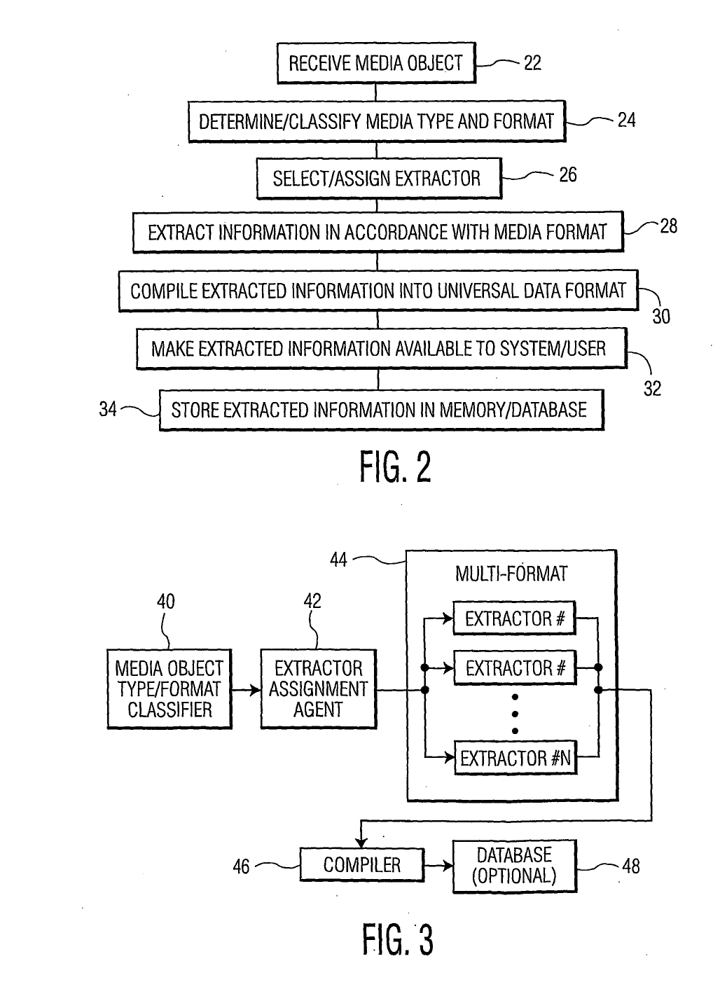

FIG. 2 is a flow diagram of a process for performing unified extraction in accordance with the present invention. FIG. 3 is a functional block diagram of a unified extractor in accordance with the present invention. Referring to FIGS. 2 and 3, a media object, and/or a link to a media object, is received at step 22. Media objects, and/or links to media objects, may be received from any appropriate source, such as a web page on the Internet, or from a database. For example, a search system, searching for media objects (e.g., multimedia, streaming media), may locate web pages comprising information related to the searched-for media objects. Links to these web pages may be provided, by the search system, to a unified extractor in accordance with the present invention. The linked web pages are analyzed to determine the media object's type and format at step 24 by media object type and format classifier 40. Media object type and format classifier 40 may be any processor or software entity capable of determining the type and format of the received media object. Thus, media object type and format classifier 40 may comprise a personal computer, a server processor, a main frame computer, a microprocessor, a software code segment, or a combination thereof. Media objects may comprise any combination of media objects that are compliant with Dublin Core, MPEG-7, XML, or other developed relationship standard where representative metadata is defined. (forms of metadata supported are not constrained by the operation of the invention). Examples of media object types include audio, video, textual, multimedia, and streaming media. Examples of media object formats include REALAUDIO®, REALVIDEO®, REALMEDIA®, APPLE QUICKTIME®, MICROSOFT WINDOWS® MEDIA FORMAT, QUICKTIME®, MPEG-2 LAYER III AUDIO, and MP3®. In one embodiment of the invention, for example, the media object's type and format are determined by evaluating the file extension of the media object, the MIME type, recognizing patterns in a URI for the media object, analyzing a metafile that comprises the media object, or a combination thereof. MIME (Multipurpose Internet Mail Extensions) refers to a standard commonly used on the Internet, which specifies the format used for email communication. The MIME format standard is also used as part of the Hypertext Transfer Protocol (HTTP), which is the protocol most commonly used by processors, such as web servers and web browsers, on the Internet to communicate with each other. The recognition of patterns in a media object's URI (preferably full URI), helps in determining the structure of a media metafile that contains a media object, and the meta type that corresponds to the structure. A metafile is a text readable file (ASCII, XML) that comprises a structure that corresponds to a specific media type (for example, Real Networks uses RAM or SMIL metafiles to describe and comprise at least one REAL media object). Synchronized Multimedia Integration Language (SMIL) files are HTML like files that use a XML syntax for bundling video, audio, text, graphic images and hyperlinks. The information, from the sources listed above, helps in classifying the family of encoding of a media object (for example, REALMEDIA®, WINDOWS MEDIA PLAYER®, MP3®) and the stream format of the media object (REAL G2® VIDEO, WINDOWS® AUDIO 4, MP3PRO®).

Once the type and format of the media object have been classified, the extractor assignment agent 42, selects and assigns the classified media object to one of the extractors in multi-format extractor 44, at step 26. Extractor assignment agent 42 may be any processor of software entity capable of determining the type and format of the received media object. Thus, extractor assignment agent 42 may comprise a personal computer, a server processor, a main frame computer, a microprocessor, a software code segment, or a combination thereof. Multi-format extractor 44 comprises a plurality of extractors, preferably within a single device or program, for extracting information, such as metadata, from each media object. Examples of extractors contained in multi-format extractor 44 include extractors compatible with REALAUDIO®, REALVIDEO®, REALMEDIA®, APPLE QUICKTIME®, MICROSOFT WINDOWS® MEDIA FORMAT, QUICKTIME®, MPEG-2 LAYER III AUDIO, and MP3® formats. Multi-format extractor 44 may be any processor of software entity capable of determining the type and format of the received media object. Thus, multi-format extractor 44 may comprise a personal computer, a server processor, a main frame computer, a microprocessor, a software code segment, or a combination thereof. At step 28, the assigned extractor extracts information, such as metadata, from the media object in accordance with that media object's media format.

At step 30, the extracted information is compiled by compiler 46 into a universal data structure, such that the format of the universal data structure is compatible with a plurality of media object formats. That is, regardless of the type and format of the media object being extracted, the extracted information is compiled into a single format compatible with all subsequent processing, thus negating the requirement for separate interfaces and processors for each media object type and format. Compiler 46 may be any processor of software entity capable of determining the type and format of the received media object. Thus, compiler 46 may comprise a personal computer, a server processor, a main frame computer, a microprocessor, a software code segment, or a combination thereof.

In one embodiment of the invention, extraction commands are dispatched to the multi-format extractor 44 and extracted information is compiled into a universal data format via a Java process utilizing a Java Native Interface (JNI). Java™ is a well known programming language commonly used to write programs embedded in Internet web pages. Java™ programs utilize streams. A Java™ stream may be visualized as data that is provided to or received from a Java™ program. JNI is a programming interface for interfacing Java™ applications with applications written in other languages. The term “native” refers to native methods. A native method is a function written in a language other than Java, such as C, C++, assembly, for example. Thus JNI is a programming interface for interfacing Java™ applications with native methods. In accordance with the present invention, the multi-format extractor 44 comprises an extractor object (i.e., extractor) corresponding to each of the possible stream types (i.e., media type and format) that the Java process delivers to the multi-format extractor 44 for metadata extraction. Furthermore, extracted metadata is incorporated into a single stream type by compiler 46. The extracted metadata is compiled to be compatible with media object standards such as Dublin Core, MPEG-7, XML, or other developed relationship standard where representative metadata is defined. In another embodiment of the invention, extracted metadata is formatted to be compatible with media object standards through the use of style sheets. A style sheet is a programming tool that allows a user/programmer to control aspects of style, such as font, color, margins, and typeface, of a web page.

Extracted information is made available to the search system, a user, or both at step 32. In one embodiment of the invention, extracted information is enqueued on a data queue and is available to all agents (e.g., processors, code segments) in the search system. Optionally, the extracted information is stored in a database 48 at step 34. Database 48 may comprise any type of memory storage, a relational database management system (DBMS) for storage and database management, or a combination thereof. Thus, the information stored in database 48 may be accessible to the system for subsequent processing.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, high density disk, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

What is claimed is:

1. A method for extracting information from media objects, said method comprising the steps of:
determining a format of a media object;
selecting a format compliant extractor compatible with said determined format;
extracting information from said media object with said format compliant extractor; and
compiling said extracted information in accordance with a universal data structure, wherein a format of said universal data structure is compatible with a plurality of media object formats.

2. A method in accordance with claim 1, wherein said media object comprises at least one of multimedia and streaming media.

3. A method in accordance with claim 1, wherein said extracted information comprises metadata related to said media object.

4. A method in accordance with claim 1, wherein said step of determining a format of said media object comprises evaluating at least one of a file extension of said media object, a multipurpose internet mail extensions (MIME) type of said media object, recognizing patterns in a URI for said media object, an analyzing a metafile that comprises said media object.

5. A method in accordance claim 1, wherein said media object format is compatible with at least one standard selected from the group comprising Dublin Core, MPEG-7, XML and a developed relationship standard where representative metadata is defined.

6. A system for extracting information from media objects, said system comprising:
a media object classifier (40) for determining a format of a media object;
an extractor assignment agent (42) for selecting a format compliant extractor compatible with said determined format;
a multi-format extractor (44) comprising a plurality of extractors, at least one of said plurality of extractors being said format compliant extractor, wherein said format compliant extractor extracts information from said media object; and
a compiler (46) for compiling said extracted information in accordance with a universal data structure, wherein a format of said universal data structure is compatible with a plurality of media object formats.

7. A system in accordance with claim 6, further comprising a database (48) that stores said extracted information.

8. A system in accordance with claim 6, wherein said media object comprises at least one of multimedia and streaming media.

9. A system in accordance with claim 6, wherein said extracted information comprises metadata related to said media object.

10. A system in accordance with claim 6, wherein said media object classifier (40) evaluates at least one of a file extension of said media object, a multipurpose internet mail extensions (MIME) type of said media object to determine said format of said media object, recognizing patterns in a URI for said media object, and analyzing a metafile that comprises said media object.

11. A system in accordance with claim 6, wherein said extracted information comprises metadata related to said media object.

12. A program readable medium having embodied thereon a program for causing a processor to extract information from media objects, said program readable medium comprising:
means for causing said processor to determine a format of a media object;
means for causing said processor to select a format compliant extractor compatible with said determined format;
means for causing said processor to extract information from said media object with said format compliant extractor; and
means for causing said processor to compile said extracted information in accordance with a universal data structure, wherein a format of said universal data structure is compatible with a plurality of media object formats.

13. A program readable medium in accordance with claim 12, wherein said media object comprises at least one of multimedia and streaming media.

14. A program readable medium in accordance with claim 12, wherein said extracted information comprises metadata related to said media object.

15. A program readable medium in accordance with claim 12, wherein said means for causing said processor to determine a format of said media object comprises evaluating at least one of a file extension of said media object, a multipurpose internet mail extensions (MIME) type of said media object, recognizing patterns in a URI for said media object, and analyzing a metafile that comprises said media object.

16. A program readable medium in accordance with claim 12, wherein said media object format is compatible with at least one standard selected from the group comprising Dublin Core, MPEG-7, XML, and a developed relationship standard where representative metadata is defined.

17. A data signal embodied in a carrier wave comprising:
a determine format code segment for determining a format of a media object;
a select extractor code segment for selecting a format compliant extractor compatible with said determined format;
an extract code segment for extracting information from said media object with said format compliant extractor; and
a compile code segment for compiling said extracted information in accordance with a universal data structure, wherein a format of said universal data structure is compatible with a plurality of media object formats.

18. A data signal in accordance with claim 17, wherein said media object comprises at least one of multimedia and streaming media.

19. A data signal in accordance with claim 17, wherein said extracted information comprises metadata related to said media object.

20. A data signal in accordance with claim 17, wherein said determine format code segment evaluates at least one of a file extension of said media object a multipurpose internet mail extensions (MIME) type of said media object, recognizing patterns in a URI for said media object, and analyzing a metafile that comprises said media object

21. A data signal in accordance with claim 17, wherein said media object format is compatible with at least standard selected from the group comprising Dublin Core, MPEG-7, XML, and a developed relationship standard where representative metadata is defined
